(19) United States
(12) Patent Application Publication
(10) Pub. No.: US 2026/0147679 A1
(43) Pub. Date: May 28, 2026

(54) CIRCUIT DETECTION METHOD AND CIRCUIT DETECTION DEVICE

(71) Applicant: REALTEK SEMICONDUCTOR CORPORATION, HSINCHU (TW)

(72) Inventors: ZI-YU LI, HSINCHU (TW); YANG-DI LIN, HSINCHU (TW); CHI-FU LU, HSINCHU (TW)

(21) Appl. No.: 19/393,899

(22) Filed: Nov. 19, 2025

(30) Foreign Application Priority Data
Nov. 22, 2024 (TW) 113145226

(51) Int. Cl. G06F 11/22

(52) U.S. Cl. CPC G06F 11/2273

(57) ABSTRACT

A circuit detection method executed by a processor reading at least command stored in a memory is disclosed herein. The circuit detection method includes following steps: detecting whether a destination power domain corresponding to a destination circuit is in an active state; detecting whether an intermediate power domain corresponding to an intermediate circuit preceding the destination circuit is in an inactive state; and if the intermediate power domain corresponding to the intermediate circuit is in the inactive state and the destination domain corresponding to the destination circuit is in the active state, generating a circuit detection report.

### BACKGROUND OF THE INVENTION

### 1. Field of the Invention

The present disclosure relates to a circuit detection method and a circuit detection device, especially to a circuit detection method and a circuit detection device that can detect standard components located between different power domains.

### 2. Description of Related Art

In circuit design involving multiple power domains, when power domains corresponding to a source circuit and a destination circuit are in active states (ON states), if a power domain corresponding to an intermediate circuit between the source circuit and the destination circuit is in an inactive state (OFF state), existing circuit detection methods or devices can only detect intermediate circuits of the buffer type, and are unable to detect other types of standard cells. In addition, when power domains corresponding to multiple circuits transition from an inactive state to an active state, existing circuit detection methods or devices can only detect intermediate circuits of the isolation cell type, and are unable to detect other types of standard cells.

### SUMMARY OF THE INVENTION

In some aspects, an object of the present disclosure is to, but not limited to, provides a circuit detection method and a circuit detection device that makes an improvement to the prior art.

An embodiment of a circuit detection method, executed by a processor reading at least command stored in a memory, includes: detecting whether a destination power domain corresponding to a destination circuit is in an active state; detecting whether an intermediate power domain corresponding to an intermediate circuit preceding the destination circuit is in an inactive state; and if the intermediate power domain corresponding to the intermediate circuit is in the inactive state, and the destination domain corresponding to the destination circuit is in the active state, generating a circuit detection report.

An embodiment of a circuit detection device includes a memory and a processor. The memory is configured to store at least one command. The processor is configured to read the at least one command stored in the memory to execute following steps: detecting whether a destination power domain corresponding to a destination circuit is in an active state; detecting whether an intermediate power domain corresponding to an intermediate circuit preceding the destination circuit is in an inactive state; and if the intermediate power domain corresponding to the intermediate circuit is in the inactive state, and the destination power domain corresponding to the destination circuit is in the active state, generating a circuit detection report.

Technical features of some embodiments of the present disclosure make an improvement to the prior art. The circuit detection method and the circuit detection device of the present disclosure are configured to detect standard components located between different power domains.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a circuit detection device of the present disclosure.

FIG. 2 shows an embodiment of a flow diagram of a circuit detection method of the present disclosure.

FIG. 3 shows an embodiment of a flow diagram of a circuit detection method of the present disclosure.

### DETAILED DESCRIPTION OF THE PREFERRED EMBODIMENTS

To address the problem that existing circuit detection methods or devices are unable to detect all types of standard cells, the present disclosure provides a circuit detection method and a circuit detection device, which will be described in detail below.

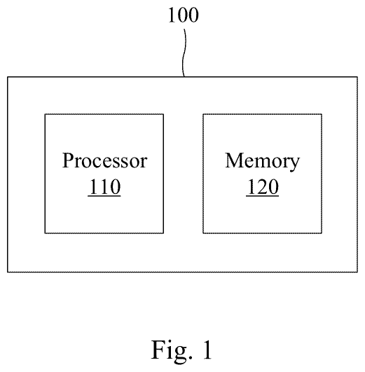

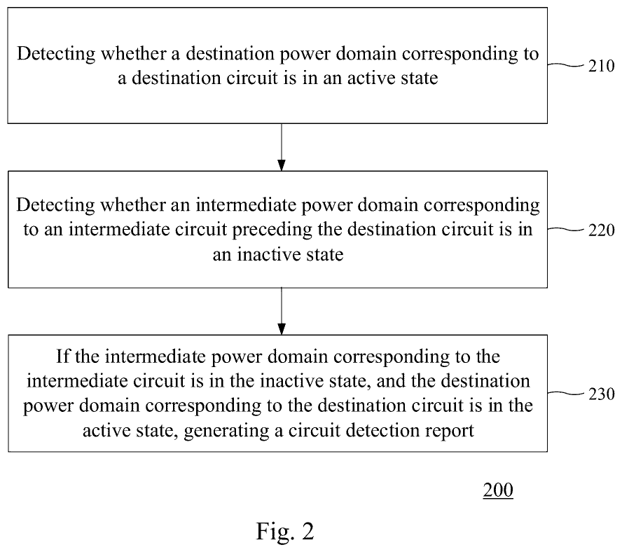

FIG. 1 shows an embodiment of a circuit detection device 100 of the present disclosure. As shown in the figure, the circuit detection device 100 includes a processor 110 and a memory 120. The memory 120 is configured to store at least one command. The processor 110 is configured to read the at least one command to perform a circuit detection process. To facilitate understanding of the operation of the circuit detection device 100, please also refer to FIG. 2, which is a flow diagram of a circuit detection method 200 of the present disclosure.

Referring to step 210 of FIG. 2, detecting whether a destination power domain corresponding to a destination circuit is in an active state. For example, the circuit detection method 200 may be configured to detect whether a destination power domain corresponding to a destination circuit is in an active state (ON state). In some embodiments, the destination circuit may be a plurality of power supply sets (all supply set), a designated power supply set (specified supply set), or a designated circuit component (specified object). For example, the power supply set includes components related to power supply. The circuit component may be any instantiated module, such as a PCIe (Peripheral Component Interconnect Express) module, a comparator, and the like.

Referring to step 220 of FIG. 2, detecting whether an intermediate power domain corresponding to an intermediate circuit preceding the destination circuit is in an inactive state. For example, the circuit detection method 200 may be configured to detect whether the intermediate power domain corresponding to the intermediate circuit preceding the destination circuit is in an inactive state (OFF state). In some embodiments, the intermediate circuit may be a plurality of power supply sets (all supply set), a designated power supply set (specified supply set), or a designated circuit component (specified object). For example, the power supply set includes components related to power supply. The circuit component may be a PCIe module, a comparator, and the like.

Referring to step 230 of FIG. 2, if the intermediate power domain corresponding to the intermediate circuit is in the inactive state, and the destination power domain corresponding to the destination circuit is in the active state, generating a circuit detection report. For example, if the intermediate power domain corresponding to the intermediate circuit is in an inactive state (OFF state), and the destination power domain corresponding to the destination circuit is in an active state (ON state), the circuit detection report is generated.

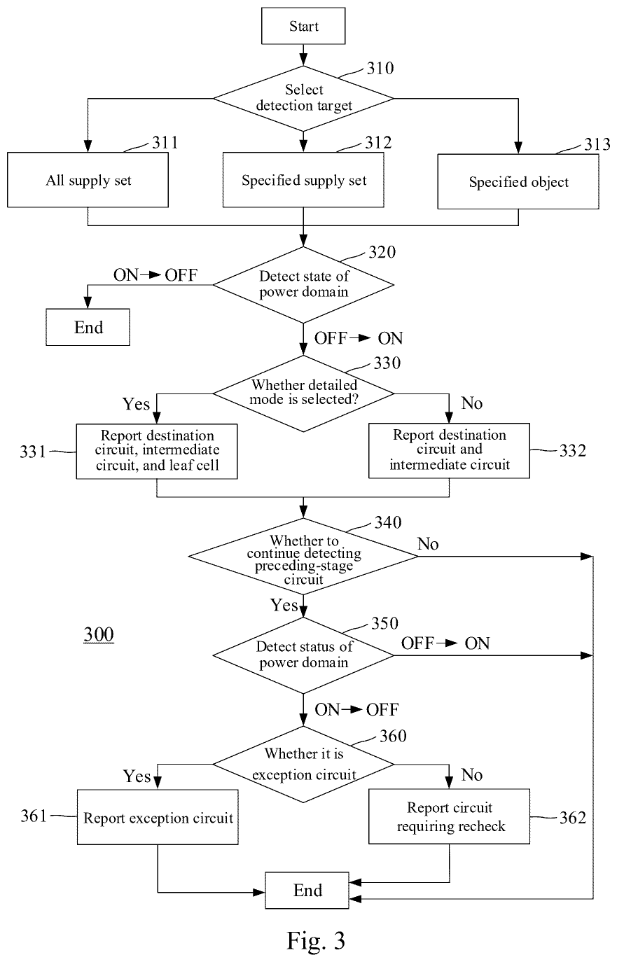

FIG. 3 shows an embodiment of a flow diagram of a circuit detection method 300 of the present disclosure. Referring to step 310 of FIG. 3, the circuit detection method 300 may first select a detection target. For example, a user may select to detect a plurality of power supply sets (all supply set) of all power domains as shown in step 311; or the user may select to detect a designated power supply set (specified supply set) of partial power domains as shown in step 312; or the user may select to detect a designated circuit component (specified object) as shown in step 313.

Referring to step 320 of FIG. 3, for the selected detection target, detecting a state of a power domain. It should be noted that, in addition to selecting a detection target, the circuit detection method 300 of the present disclosure may further perform detection of the above target within different power domains. For example, the present disclosure may detect the destination power domain corresponding to the destination circuit, the source power domain corresponding to the source circuit, and the intermediate power domain corresponding to the intermediate circuit between the two.

It should be noted that step 320 of FIG. 3 corresponds to steps 210, 220 of FIG. 2, and the following provides an illustrative explanation. The circuit detection method 300 first detects whether the destination power domain corresponding to the destination circuit is in the active state, and detects whether the intermediate power domain corresponding to the intermediate circuit preceding the destination circuit is in the inactive state. For example, to detect the above power domain states, the circuit detection method 300 may determine based on power states of the power domains. Specifically, the circuit detection method 300 may detect whether the destination power domain is in an active state according to a destination power state of the destination power domain, and may detect whether the intermediate power domain is in an inactive state according to an intermediate power state of the intermediate power domain. If the destination power state of the destination power domain is power ON, it can be determined that the destination power domain is in an active state. Furthermore, if the intermediate power state of the intermediate power domain is power OFF, it can be determined that the intermediate power domain is in an inactive state.

If the intermediate power domain corresponding to the intermediate circuit is in an inactive state (OFF state), and the destination power domain corresponding to the destination circuit is in an active state (ON state), then the power domains from the intermediate circuit to the destination circuit transition from an inactive state to an active state (OFF→ON). In this case, the circuit detection method 300 continues to execute a subsequent step 330. Conversely, if the intermediate power domain corresponding to the intermediate circuit is in an active state (ON state), and the destination power domain corresponding to the destination circuit is in an inactive state (OFF state), then the power domains from the intermediate circuit to the destination circuit transition from an active state to an inactive state (ON→OFF). Since such a power domain transition is not the state targeted by the present disclosure, the circuit detection method 300 ends at this point.

Referring to step 330 of FIG. 3, the circuit detection method 300 determines whether a detailed mode is selected. For example, determining whether the user selects a verbose option of low-power detection (Conformal Low Power, CLP). If the user selects the verbose option, step 331 is executed, and the circuit detection method 300 generates a circuit detection report that details the destination circuit, the intermediate circuit, and all passed leaf cells. If the user does not select the verbose option, step 332 is executed, and the circuit detection method 300 generates a circuit detection report that only reports the destination circuit and a first intermediate circuit during the power domain transition.

Subsequently, referring to step 340 of FIG. 3, the circuit detection method 300 determines whether to continue detecting a preceding-stage circuit. It should be noted that, as described above, the circuit detection method 300 may detect the destination power domain corresponding to the destination circuit, the intermediate power domain corresponding to the intermediate circuit, and the source power domain corresponding to the source circuit. Therefore, after completing detection of the destination power domain corresponding to the destination circuit and the intermediate power domain corresponding to the intermediate circuit in step 320, the circuit detection method 300 may further determine in step 340 whether to continue detecting the source power domain corresponding to the source circuit.

If it is determined not to continue detecting a preceding-stage circuit, the circuit detection method 300 ends. If it is determined to continue detecting a preceding-stage circuit, step 350 is executed, and the circuit detection method 300 continues to detect the status of the source power domain corresponding to the source circuit.

If the source power domain corresponding to the source circuit is in an inactive state (OFF state), and the intermediate power domain corresponding to the intermediate circuit is in an active state (ON state), then the power domains from the source circuit to the intermediate circuit transition from an inactive state to an active state (OFF→ON), and the circuit detection method 300 ends. Conversely, if the source power domain corresponding to the source circuit is in an active state (ON state), and the intermediate power domain corresponding to the intermediate circuit is in an inactive state (OFF state), then the power domains from the source circuit to the intermediate circuit transition from an active state to an inactive state (ON→OFF), and the circuit detection method 300 continues to execute a subsequent step 360.

Referring to step 360 of FIG. 3, the circuit detection method 300 determines whether the destination circuit is an exception circuit. If the destination circuit is not an exception circuit, step 362 is executed, and a circuit requiring recheck is reported. For example, the circuit detection report includes a recheck tag to notify the user to perform detection. If the destination circuit is an exception circuit, step 361 is executed, and the exception circuit is reported. For example, the circuit detection report includes an exception tag to inform the user that an exception circuit is included. However, the present disclosure is not limited to this embodiment. In other embodiments, the circuit detection method 300 may also determine whether the intermediate circuit or the source circuit is an exception circuit, depending on actual requirements

In some embodiments, the circuit detection device 100 and the circuit detection methods 200, 300 may be applied to a low-power detection field. For example, the circuit detection device 100 and the circuit detection methods 200, 300 may be applied in an environment of low-power detection (e.g., Conformal Low Power, CLP). In some embodiments, the circuit detection device 100 and the circuit detection methods 200, 300 are required to utilize a Unified Power Format (UPF) file.

It should be noted that the present disclosure is not limited to the embodiments as shown in FIG. 1 to FIG. 3, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The circuit detection method and the circuit detection device of the present disclosure, by tracing back two circuit stages from the destination circuit, can determine the states of the power domain of the entire circuit design. For example, by tracing from the destination circuit to the intermediate circuit and the source circuit, the circuit detection method and the circuit detection device of the present disclosure can determine whether the power domains of the entire circuit design are in an active state or are in an inactive state. Therefore, the circuit detection method and the circuit detection device of the present disclosure are capable of detecting standard cells located between different power domains.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A circuit detection method, executed by a processor reading at least command stored in a memory, comprising:
detecting whether a destination power domain corresponding to a destination circuit is in an active state;
detecting whether an intermediate power domain corresponding to an intermediate circuit preceding the destination circuit is in an inactive state; and
if the destination power domain corresponding to the destination circuit is in the active state, and the intermediate power domain corresponding to the intermediate circuit is in the inactive state, generating a circuit detection report.

2. The circuit detection method of claim 1, wherein detecting whether the destination power domain corresponding to the destination circuit is in the active state comprises:
detecting whether the destination power domain is in the active state according to a destination power state of the destination power domain.

3. The circuit detection method of claim 2, wherein detecting whether the intermediate power domain corresponding to the intermediate circuit is in the inactive state comprises:
detecting whether the intermediate power domain is in the inactive state according to an intermediate power state of the intermediate power domain.

4. The circuit detection method of claim 1, wherein the circuit detection report comprises the destination circuit and the intermediate circuit, or the circuit detection report comprises the destination circuit, the intermediate circuit, and a plurality of leaf cells between the destination circuit and the intermediate circuit.

5. The circuit detection method of claim 1, further comprising:
detecting whether a source power domain corresponding to a source circuit is in the active state;
wherein if the destination power domain corresponding to the destination circuit is in the active state, and the intermediate power domain corresponding to the intermediate circuit is in the inactive state, generating the circuit detection report comprises:
if the destination power domain corresponding to the destination circuit is in the active state, the intermediate power domain corresponding to the intermediate circuit is in the inactive state, and the source power domain corresponding to the source circuit is in the active state, generating the circuit detection report.

6. The circuit detection method of claim 5, further comprising:
if the source power domain corresponding to the source circuit is in the active state, determining whether the destination circuit is an exception circuit; and
if it is determined that the destination circuit is not the exception circuit, generating the circuit detection report comprising a recheck tag.

7. The circuit detection method of claim 6, further comprising:
if it is determined that the destination circuit is the exception circuit, generating the circuit detection report comprising an exception tag.

8. The circuit detection method of claim 1, wherein the circuit detection method is applied to a low-power detection field.

9. The circuit detection method of claim 1, wherein the destination circuit comprises one of a plurality of power supply sets, a designated power supply set, and a designated circuit component.

10. The circuit detection method of claim 1, wherein the intermediate circuit comprises one of a plurality of power supply sets, a designated power supply set, and a designated circuit component.

11. A circuit detection device, comprising:
a memory, configured to store at least one command; and
a processor, configured to read the at least one command stored in the memory to execute following steps:
detecting whether a destination power domain corresponding to a destination circuit is in an active state;
detecting whether an intermediate power domain corresponding to an intermediate circuit preceding the destination circuit is in an inactive state; and
if the destination power domain corresponding to the destination circuit is in the active state, and the intermediate power domain corresponding to the intermediate circuit is in the inactive state, generating a circuit detection report.

12. The circuit detection device of claim 11, wherein the processor is further configured to read the at least one command stored in the memory to execute:
detecting whether the destination power domain is in the active state according to a destination power state of the destination power domain.

13. The circuit detection device of claim 12, wherein the processor is further configured to read the at least one command stored in the memory to execute:
detecting whether the intermediate power domain is in the inactive state according to an intermediate power state of the intermediate power domain.

14. The circuit detection device of claim 11, wherein the circuit detection report comprises the destination circuit and the intermediate circuit, or the circuit detection report comprises the destination circuit, the intermediate circuit, and a plurality of leaf cells between the destination circuit and the intermediate circuit.

15. The circuit detection device of claim 11, wherein the processor is further configured to read the at least one command stored in the memory to execute:
detecting whether a source power domain corresponding to a source circuit is in the active state; and
if the destination power domain corresponding to the destination circuit is in the active state, the intermediate power domain corresponding to the intermediate circuit is in the inactive state, and the source power domain corresponding to the source circuit is in the active state, generating the circuit detection report.

16. The circuit detection device of claim 15, wherein the processor is further configured to read the at least one command stored in the memory to execute:
if the source power domain corresponding to the source circuit is in the active state, determining whether the destination circuit is an exception circuit; and
if it is determined that the destination circuit is not the exception circuit, generating the circuit detection report comprising a recheck tag.

17. The circuit detection device of claim 16, wherein the processor is further configured to read the at least one command stored in the memory to execute:
if it is determined that the destination circuit is the exception circuit, generating the circuit detection report comprising an exception tag.

18. The circuit detection device of claim 11, wherein the circuit detection device is applied to a low-power detection field.

19. The circuit detection device of claim 11, wherein the destination circuit comprises one of a plurality of power supply sets, a designated power supply set, and a designated circuit component.

20. The circuit detection device of claim 11, wherein the intermediate circuit comprises one of a plurality of power supply sets, a designated power supply set, and a designated circuit component.
